(19) United States
(12) Patent Application Publication
(10) Pub. No.: US 2012/0075178 A1
(43) Pub. Date: Mar. 29, 2012

(54) APPARATUS AND METHOD FOR GENERATING DYNAMIC RESPONSE

(75) Inventors: Jeong Mi CHO, Seongnam-si (KR); Jeong Su Kim, Yongin-si (KR); Byung Kwan Kwak, Yongin-si (KR); Chi Youn Park, Suwon-si (KR)

(73) Assignee: SAMSUNG ELECTRONICS CO., LTD., Suwon-si (KR)

(21) Appl. No.: 13/243,308

(22) Filed: Sep. 23, 2011

(30) Foreign Application Priority Data
Sep. 27, 2010 (KR) 10-2010-0093278

(51) Int. Cl. G06F 3/01

(52) U.S. Cl. 345/156

(57) ABSTRACT

A dynamic response generating apparatus and method that may analyze an intention of a user based on user input information received from an inputting device, may analyze at least one of first response information with respect to the analyzed intention of the user, context information associated with the user input information, user motion information, and environmental information, may dynamically determine a modality with respect to the first response information, may process the first response information, and may dynamically generate second response information in a form of via the determined modality.

### CROSS-REFERENCE TO RELATED APPLICATIONS

This application claims the priority benefit of Korean Patent Application No. 10-2010-0093278, filed on Sep. 27, 2010, in the Korean Intellectual Property Office, the disclosure of which is incorporated herein by reference.

### BACKGROUND

1. Field

Example embodiments relate to a response generating apparatus and method, and more particularly, to a conversational user interface (UI).

2. Description of the Related Art

A user interface (UI) is a physical or virtual medium for temporary or permanent access enabling communication between a user and an object or a system, such as a machine, a computer program, and the like.

The UI has been developed using various formats. Recently, a conversational UI that provides a customized system response in response to user input information inputted through an interaction between the user and the system, has drawn attention.

In the conventional UI, the system response may be the system finally shown to the user, and a spontaneity and an intellectual capacity of the conversational UI may be determined based on how natural and intellectual is the system response.

The conversational UI may provide the system response in various modality forms.

The modality may be the channel through which information is exchanged between humans or between machines, and a visual modality and a hearing modality may have respective distinguishing characteristics.

For example, when a mobile terminal exchanges information using the visual modality, the visual modality may be a screen, and when the mobile terminal exchanges information using the hearing modality, the hearing modality may be a sound occurring over a phone used during conversation.

The conversational UI may accurately determine the system response desired by the user, and provide the system response in a corresponding modality form.

### SUMMARY

The foregoing and/or other aspects are achieved by providing a dynamic response generating apparatus, the apparatus including a controller to control an operation of the dynamic response generating system, an information receiving unit to receive user input information from an inputting device, an analyzing unit to analyze an intention of a user based on the user input information, a first response generating unit to generate first response information associated with the analyzed intention of the user, a modality determining unit to dynamically determine a modality with respect to the first response information by analyzing at least one of the first response information, context information associated with the user input information, user motion information, and environmental information, a second response generating unit to dynamically generate second response information in a form of the determined modality by processing the first response information, and an outputting unit to output the second response information and a content in the form of the determined modality.

The inputting device may include at least one of a voice recognition device, an image recognition device, a text recognizing device, a motion recognition sensor, a temperature sensor, an illuminance sensor, and a humidity sensor.

The user input information may include at least one of a voice of the user, a motion of the user, a text, and an image inputted through the inputting device.

The apparatus may further include an application execution unit to execute an application corresponding to the intention of the user.

When a modality with respect to the user input information is directly received, the second response generating unit may generate the second response information in a form of the directly received modality.

The apparatus may further include a situation analyzing unit to analyze a situation of the user to determine the modality based on at least one of the first response information, the context information, the user motion information, and the environmental information.

The situation analyzing unit may analyze the situation of the user based on one of a type of the content, playtime of the content, or combinations thereof.

The modality determining unit may dynamically determine the modality by analyzing the situation of the user.

The context information may include at least one of dialog context information, domain context information, or combinations thereof.

The modality determining unit may determine the modality by separately analyzing one of the first response information, the context information associated with the user input information, the user motion information, and environmental information.

The modality determining unit may determine the modality by analyzing together at least two of the first response information, the context information associated with the user input information, the user motion information, and environmental information.

When multiple modalities exist, the modality determining unit may determine priorities with respect to the multiple modalities.

The foregoing and/or other aspects are achieved by providing a dynamic response generating method, the method including receiving user input information from an inputting device, analyzing an intention of a user based on the user input information, generating first response information associated with the analyzed intention of the user, dynamically determining a modality with respect to the first response information by analyzing at least one of the first response information, context information associated with the user input information, user motion information, and environmental information, dynamically generating second response information in a form of the determined modality by processing the first response information, and outputting the second response information and a content in the form of the determined modality.

Additional aspects of embodiments will be set forth in part in the description which follows and, in part, will be apparent from the description, or may be learned by practice of the disclosure.

### BRIEF DESCRIPTION OF THE DRAWINGS

These and/or other aspects will become apparent and more readily appreciated from the following description of embodiments, taken in conjunction with the accompanying drawings of which:

FIG. 1 is a block diagram illustrating a configuration of a system where a dynamic response generating apparatus is applied according to example embodiments;

FIG. 2 is a block diagram illustrating a configuration of a dynamic response generating apparatus according to example embodiments;

FIG. 3 is a flowchart illustrating a dynamic response generating method according to example embodiments;

FIG. 4 is a diagram illustrating an example of a possible situation of a user occurring when a system response is generated using a dynamic response generating apparatus according to example embodiments;

FIG. 5 is a diagram illustrating an example of determining a modality using a dynamic response generating apparatus according to example embodiments; and

FIGS. 6 through 9 are diagram illustrating examples of applying a dynamic response generating apparatus to a conversational UI according to example embodiments.

### DETAILED DESCRIPTION

Reference will now be made in detail to embodiments, examples of which are illustrated in the accompanying drawings, wherein like reference numerals refer to the like elements throughout. Embodiments are described below to explain the present disclosure by referring to the figures.

The dynamic response generating apparatus may be based on a user interface (UI) that is able to input and/or output various modalities, such as a voice, a text, an image, a motion, a touch, and the like.

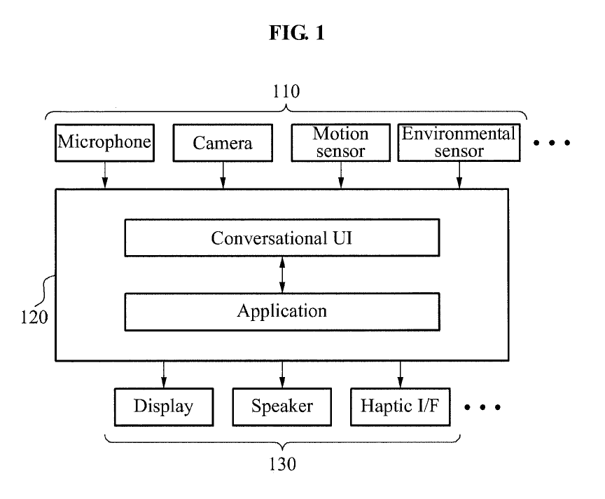

FIG. 1 illustrates a configuration of a system where a dynamic response generating apparatus 120 is applied according to example embodiments.

Referring to FIG. 1, the system where the dynamic response generating apparatus 120 is applied may control an application using a conversational user interface (UI).

The conversational UI may receive user multi-modal input information from various input devices 110, such as a microphone, a camera, a keyboard, a motion sensor, a temperature sensor, an illuminance sensor, a humidity sensor, and the like, and may sense user information and environmental information.

The dynamic response generating apparatus 120 may analyze the received user multi-modal input information, the user information, the environmental information, and the like to generate a system response, and may output the system response in a multi-modal form through various output devices 130, such as a display, a speaker, a haptic interface, and the like.

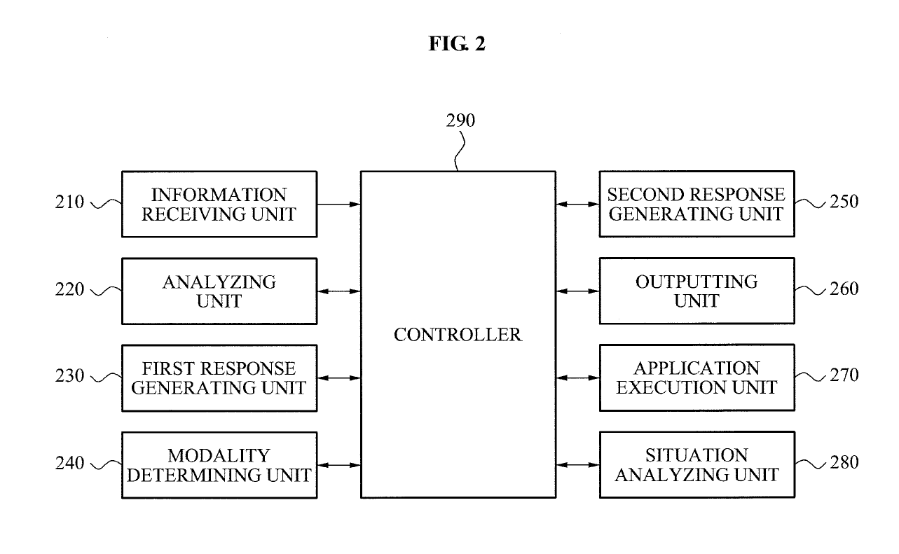

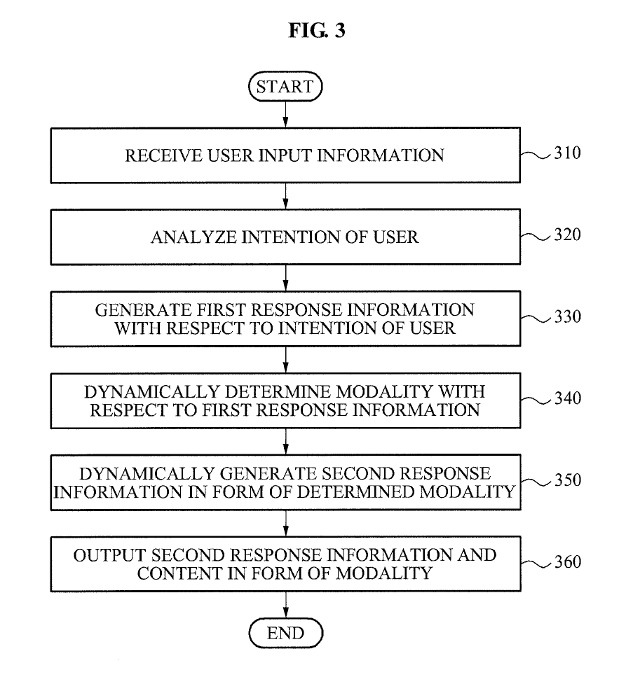

FIG. 2 illustrates a configuration of a dynamic response generating apparatus according to example embodiments, and FIG. 3 illustrates a dynamic response generating method according to example embodiments.

Referring to FIG. 2, the dynamic response generating apparatus may include an information receiving unit 210, an analyzing unit 220, a first response generating unit 230, a modality determining unit 240, a second response generating unit 250, and an outputting unit 260, application execution unit 270, situation analyzing unit 280, and controller 290.

The dynamic response generating apparatus may analyze an intention of a user to generate first response information as a system response, may analyze the first response information and inputted various information to dynamically determine a modality, and may generate, as a final system response, second response information in a form of the determined modality.

The information receiving unit 210 receives user input information from an inputting device in operation 310.

The information receiving unit 210 may receive the user input information from various input devices, such as a voice recognition device, an image recognition device, a text recognizing device, a motion recognizing sensor, a temperature sensor, an illuminance sensor, a humidity sensor, and the like.

For example, the information receiving unit 210 may receive, through the inputting device, various user input information, such as voice of the user, a motion of the user, a text, an image, and the like.

The analyzing unit 220 analyzes the intention of the user based on the user input information in operation 320.

The first response generating unit 230 generates first response information with respect to the analyzed intention of the user in operation 330.

The modality determining unit 240 may analyze at least one of the first response information, context information associated with the user input information, user motion information, and environmental information to determine a modality with respect to the first response information in operation 340.

For example, the modality determining unit 240 may determine the modality by analyzing various context information, such as dialog context information, a domain context, and the like.

The second response generating unit 250 dynamically generates second response information in a form of the determined modality by processing the first response information in operation 350.

The outputting unit 260 outputs the second response information and content in the form of via the determined modality in operation 360.

The dynamic response generating apparatus may execute an application corresponding to the intention of the user using an application execution unit 270.

When the second response generating unit 250 directly receives a modality with respect to the user input information, the second response generating unit 250 may generate the second response information in a form of the directly received modality.

For example, when the user directly designates a modality of the system response, such as “tell me in a voice”, “show me on a screen”, and the like during a process that generates the system response, such as the first response information, and the second response information, the dynamic response generating apparatus may provide the system response in a form of the modality designated by the user.

The response generating apparatus may analyze a situation of the user based on at least one of the first response information, the context information, the user motion information, and the environmental information, and the analyzed situation of the user may be used for determining the modality.

For example, the situation analyzing unit 280 may analyze the situation of the user, based on a type of the content, a play time of the content, and the like.

The modality determining unit 240 may analyze the situation of the user to dynamically determine the modality and thus, may determine a more effective and rational modality.

The controller 290 may control an operation of the dynamic response generating apparatus.

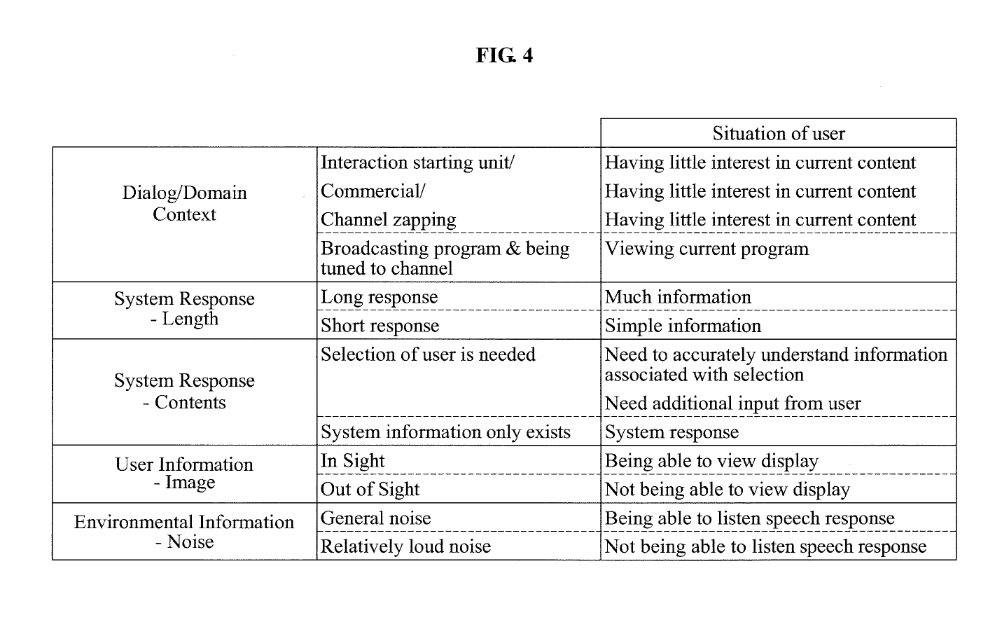

FIG. 4 illustrates an example of a possible situation of a user occurring when a system response is generated using a dynamic response generating apparatus according to example embodiments.

For ease of description, the dynamic response generating apparatus is assumed to be a conversational UI that may control a TV with a voice, an image, a motion, and the like, and may retrieve a TV content.

The dynamic response generating apparatus may analyze various situations, such as “a point in time when an interaction between the user and the dynamic response generating apparatus is performed”, “commercial being broadcasted on the TV”, “channel being zapped by the user through an interface”, “the user having little interest in a current content on the TV”, and the like, based on a result obtained by analyzing dialog context information and domain context information.

When situations correspond to “the user staying tuned to a channel for a predetermined time” and “a program, such as a drama or a movie, being broadcasted on the channel”, analysis by the dynamic response generating apparatus may determine that the user concentrates on the program.

When the system response is significantly long, analysis by the dynamic response generating apparatus may determine that the user may obtain a large amount of information from the system response.

When the system response asks the user for a selection, analysis by the response generating apparatus determines that the user may accurately understand the system response to perform the selection.

When the dynamic response generating apparatus checks user information including user location information, and determines that currently the user is not in front of the TV, analysis by the dynamic response generating apparatus may determine that the user may not be viewing the TV.

The situation of the user analyzed by the situation analyzing unit 280 may be a main factor to be used when the dynamic response generating apparatus determines the modality.

When the user concentrates on a program being broadcasted, the dynamic response generating apparatus may select a modality that does not disturb the user.

When the user obtains much information from second response information that is the system response or when the user is to accurately understand the second response information, the dynamic response generating apparatus may generate the second response information in a form of a text, as opposed to in a form of a voice. Accordingly, information is more accurately conveyed.

When the user is not able to view the TV, the dynamic response generating apparatus may provide an output in a voice, as opposed to an output on a display.

When the user is able to view the TV and is in a noisy environment, the dynamic response generating apparatus may provide an output on the display, as opposed to an output in the voice.

The dynamic response generating apparatus may analyze the dialog context information, a history associated with the domain context information, and the like and thus, may determine information associated with a time when an interaction with the user is attempted.

The dynamic response generating apparatus may analyze the domain context information, such as electronic program guide (EPG) information, current time, a current user channel, and the like and thus, may determine whether the TV broadcasts a program or a commercial.

The dynamic response generating apparatus may analyze the context information, such as a channel change history, a channel change time, a dialog history between the user and the system, and the like, and may determine whether the user is zapping channels.

The dynamic response generating apparatus may determine the EPG information, the current time, whether a current channel is broadcasting a program, and the like, may analyze an amount of time that the user stays tuned to the current channel, a number of interactions during the time, and the like and thus, may determine a degree of concentration of the user on the program.

The dynamic response generating apparatus may analyze feedback information, such as the intention of the user, EPG information search result, whether an application is provided, and the like, to determine a length of the system response.

The dynamic response generating apparatus may analyze a system dialog act to determine whether the user is asked to select a content.

The dynamic response generating apparatus may analyze an image received from a camera based on a facial recognition technology and the like, to determine whether the user is in front of the TV.

The dynamic response generating apparatus may measure a level of noise received via a microphone to determine whether it is noisy around the user.

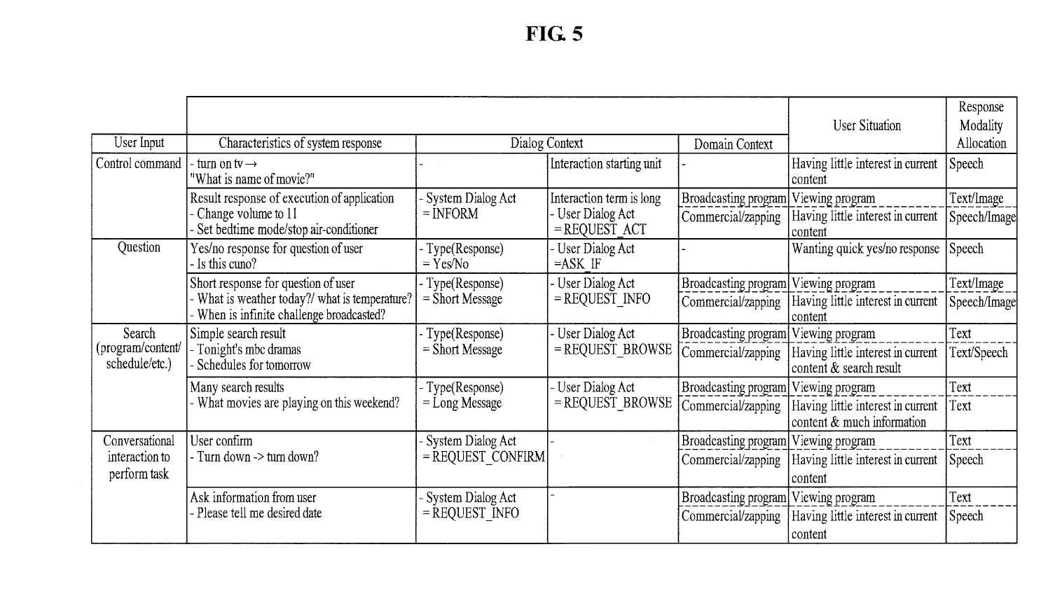

FIG. 5 illustrates an example of determining a modality using a dynamic response generating apparatus according to example embodiments.

The modality determining unit 240 may separately analyze at least one of first response information, context information associated with user input information, user motion information, and environmental information, to determine the modality.

The modality determining unit 240 may analyze together at least two the first response information, the context information associated with the user input information, the user motion information, and the environmental information, to determine the modality.

When a commerce is being broadcasted on a TV, a channel is being zapped by a user, or the user has little interest in a current TV content, the dynamic response generating apparatus may receive user input information in a voice, such as “when is news on?” and the like, and may generate second response information in a form of voice modality.

When a list of movie search results is provided as the second response information with respect to the user input information, such as “what movies are playing this weekend?” and the like, the dynamic response generating apparatus may provide the second response information in a form of a visual modality as opposed to providing in the form of the voice modality.

When the user asks a yes/no question while the user views a program, that is, when a user dialog act is ASK_IF, the dynamic response generating apparatus may analyze that the user wants a quick response with respect to yes/no and thus, may provide the second response information in the form of the voice modality.

The dynamic response generating apparatus may define a modality and a situation of the user for each of the first response information, the context information, the user information, and the environmental information to generally apply the information, may determine priorities with respect to the respective user situations and modalities of the information, and may generate the second response information.

When multiple modalities exist, the modality determining unit 240 may determine priorities with respect to the multiple modalities.

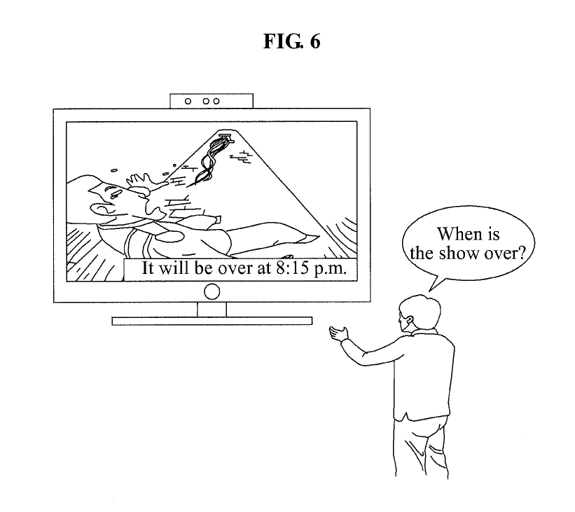

FIGS. 6 through 9 illustrate examples of applying a dynamic response generating apparatus to a conversational UI according to example embodiments.

Referring to FIG. 6, when the dynamic response generating apparatus is used as a conversational UI that searches for a TV content and the user inputs user input information using a voice, the dynamic response generating apparatus may generate second response information in a form of a voice modality and provide the second response information to the user.

When domain context information is analyzed and the analysis determines that the user continuously views a channel during a predetermined time or that the channel broadcasts a predetermined program, such as a drama or a movie, the dynamic response generating apparatus analyzes that the user concentrates on the program.

When the uses concentrates on the program, the dynamic response generating apparatus may provide the second response information in a form of a visual modality as opposed to providing the second response information in a form of the voice modality that may disturb the user.

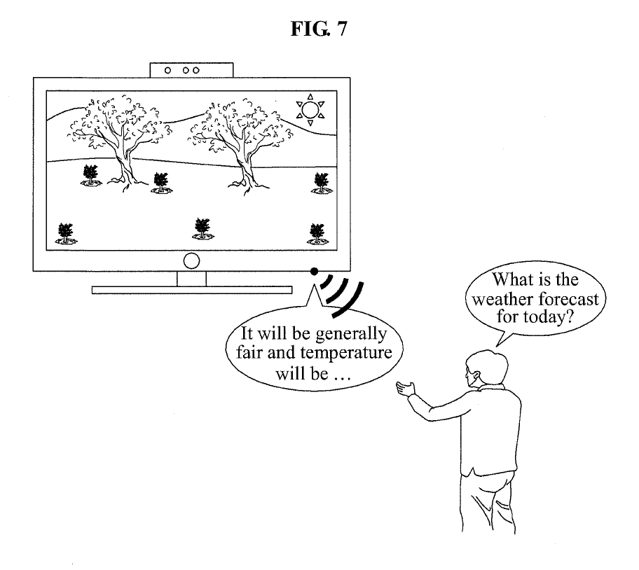

Referring to FIG. 7, when dialog context information and domain context information is analyzed and the analysis determines that a content to which the user pays little attention is being broadcasted on the TV, the dynamic response generating apparatus may provide the second response information in the form of the voice modality.

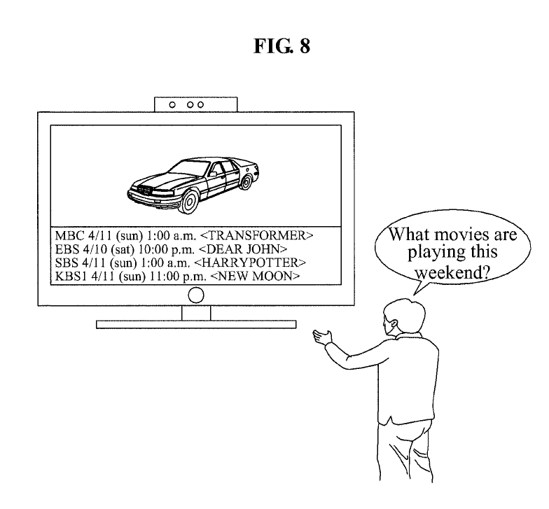

Referring to FIG. 8, when a relatively great amount of information is provided as the second information, the dynamic response generating apparatus may provide the second response information in the form of the visual modality, as oppose to providing in the form of the voice modality.

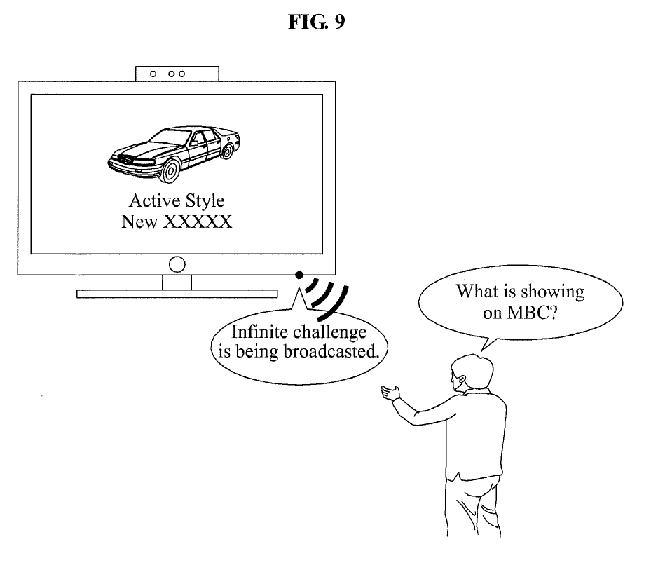

Referring to FIG. 9, when user location information is analyzed based on a camera configured to the TV and the analysis determines that the user is not able to view a TV display, the dynamic response generating apparatus may provide the second response information in the form of the voice modality.

The example embodiments may provide an optimal system response by analyzing an intention and a situation of a user, using a UI that may input and output various modalities, such as a voice, a text, an image, a motion, a touch, and the like.

The example embodiments may also provide a response modality optimized for a situation of a user by applying characteristics of a system response, conversational context information, domain context information, user information, and environmental information when an interaction between the user and a system is performed.

The method according to the above-described embodiments may be recorded in non-transitory computer-readable media including program instructions to implement various operations embodied by a computer. The media may also include, alone or in combination with the program instructions, data files, data structures, and the like. Examples of non-transitory computer-readable media include magnetic media such as hard disks, floppy disks, and magnetic tape; optical media such as CD ROM disks and DVDs; magneto-optical media such as optical disks; and hardware devices that are specially configured to store and perform program instructions, such as read-only memory (ROM), random access memory (RAM), flash memory, and the like. Examples of program instructions include both machine code, such as produced by a compiler, and files containing higher level code that may be executed by the computer using an interpreter. The described hardware devices may be configured to act as one or more software modules in order to perform the operations of the above-described embodiments, or vice versa.

Although embodiments have been shown and described, it would be appreciated by those skilled in the art that changes may be made in these embodiments without departing from the principles and spirit of the disclosure, the scope of which is defined by the claims and their equivalents.

What is claimed is:

1. A dynamic response generating apparatus, the apparatus comprising:
a controller to control an operation of the dynamic generating apparatus;
an information receiving unit to receive user input information from an inputting device;
an analyzing unit to analyze an intention of a user based on the user input information;
a first response generating unit to generate first response information associated with the analyzed intention of the user;
a modality determining unit to dynamically determine a modality with respect to the first response information by analyzing at least one of the first response information, context information associated with the user input information, user motion information, and environmental information;
a second response generating unit to dynamically generate second response information in a form of the determined modality by processing the first response information; and
an outputting unit to output the second response information and a content in the form of the determined modality.

2. The apparatus of claim 1, wherein the inputting device includes at least one of a voice recognition device, an image recognition device, a text recognizing device, a motion recognition sensor, a temperature sensor, an illuminance sensor, and a humidity sensor.

3. The apparatus of claim 1, wherein the user input information includes at least one of a voice of the user, a motion of the user, a text, and an image inputted through the inputting device.

4. The apparatus of claim 1, further comprising:
an application execution unit to execute an application corresponding to the intention of the user.

5. The apparatus of claim 1, wherein, when a modality with respect to the user input information is directly received, the second response generating unit generates the second response information in a form of the directly received modality.

6. The apparatus of claim 1, further comprising:
a situation analyzing unit to analyze a situation of the user to determine the modality based on at least one of the first response information, the context information, the user motion information, the environmental information, or combinations thereof.

7. The apparatus of claim 6, wherein the situation analyzing unit analyzes the situation of the user based on one of a type of the content and a playtime of the content.

8. The apparatus of claim 6, wherein the modality determining unit dynamically determines the modality by analyzing the situation of the user.

9. The apparatus of claim 1, wherein the context information includes at least one of dialog context information and domain context information.

10. The apparatus of claim 1, wherein the modality determining unit determines the modality by separately analyzing one of the first response information, the context information associated with the user input information, the user motion information, and environmental information.

11. The apparatus of claim 1, wherein the modality determining unit determines the modality by analyzing together at least two of the first response information, the context information associated with the user input information, the user motion information, and environmental information.

12. The apparatus of claim 11, wherein, when multiple modalities exist, the modality determining unit determines priorities with respect to the multiple modalities.

13. A dynamic response generating method, the method comprising:
receiving user input information from an inputting device;
analyzing an intention of a user based on the user input information;
generating first response information associated with the analyzed intention of the user;
dynamically determining a modality with respect to the first response information by analyzing at least one of the first response information, context information associated with the user input information, user motion information, environmental information, or combinations thereof;
dynamically generating second response information in a form of the determined modality by processing the first response information; and
outputting the second response information and a content in the form of the determined modality.

14. The method of claim 13, wherein, when a modality with respect to the user input information is directly received, the dynamically generating of the second response information comprises generating the second response information in a form of the directly received modality.

15. The method of claim 13, further comprising:
analyzing a situation of the user to determine the modality based on at least one of the first response information, the context information, the user motion information, and the environmental information.

16. The method of claim 15, wherein the determining of the modality comprises dynamically determining of the modality by analyzing the situation of the user.

17. A non-transitory computer-readable medium comprising a program for instructing a computer to perform the method of claim 13.
